(19) United States
(12) Patent Application Publication
(10) Pub. No.: US 2015/0337867 A1
(43) Pub. Date: Nov. 26, 2015

(54) BRAKE VACUUM ASPIRATOR

(71) Applicant: Ford Global Technologies, LLC, Dearborn, MI (US)

(72) Inventors: Frank Grither Costley, Plymouth, MI (US); Harbind S. Chahal, Novi, MI (US); Ralph Wayne Cunningham, Milan, MI (US); Ross Dykstra Pursifull, Dearborn, MI (US)

(73) Assignee: Ford Global Technologies, LLC, Dearborn, MI (US)

(21) Appl. No.: 14/282,232

(22) Filed: May 20, 2014

(51) Int. Cl. F04F 5/24; B60T 13/52

(52) U.S. Cl. CPC F04F 5/24; B60T 13/52

(57) ABSTRACT

A brake vacuum aspirator has a generally known construction and function and includes an optimized bypass flow path including an optimized check valve making the brake vacuum aspirator capable of a performance level not previously obtainable in brake vacuum aspirators. In particular, the brake vacuum aspirator of the exemplary embodiment of the present disclosure includes an enlarged bypass flow path for providing a proximately 9.5 ft³/min of air flow at 7″ of Hg so that the brake vacuum aspirator is capable of sufficient performance during alternating wide-open throttle and then full brake application testing simulating high performance driving such as those that may be experienced in vehicle pursuits (e.g., Police City Pursuit Testing) without using any added and costly additional equipment.

### BACKGROUND

The present disclosure generally relates to vehicles and, more particularly, relates to an improved braking system for a vehicle. Even more particularly, the present disclosure generally relates to an improved brake vacuum aspirator for use in a braking system in a passenger vehicle.

Internal combustion engines in passenger vehicles may include an intake manifold for directing air to the pistons of the internal combustion engine for use in mixing air with a fuel and completing a combustion event. Once an internal combustion engine is operating it creates a vacuum (a region in which air is present at a lower pressure) in the intake manifold causing air to be drawn into the inlet of the intake manifold and toward the combustion chambers and pistons. It is generally known in an internal combustion engine of a passenger vehicle to communicate the lower pressure in the intake manifold of the engine to a brake booster or power assist device of the braking system for use with the brake vacuum aspirator for the purpose of vacuum-assisting the brake booster and improving the operation of the power brakes of the passenger vehicle. It is generally known that a brake vacuum aspirator device may be used to enhance the engine vacuum levels for vacuum boosted automotive braking systems. Generally known vacuum aspirators provide an increased level of vacuum to the brake booster through a Venturi-type pump. The known vacuum aspirators may also include a check valve interface to the brake booster to allow the brake booster to “store” or build up a stronger vacuum. Additionally, it is generally known for a traditional vacuum aspirator to provide a bypass flow path so that when the intake manifold source pressure is lower than the booster pressure, the bypass flow path will open the vacuum source to the brake booster. A graphical flow diagram of the generally known by-pass aspirator is shown in FIG. 1.

Currently, despite the known use of a by-pass flow path, the flow restriction in the known brake vacuum aspirators may be a significant drawback in certain applications resulting in unacceptably high pedal efforts as a result of low vacuum levels. In one particular known test, the performance of the braking system is measured using repetitively applied braking simulations wherein the vehicle is alternating operated at wide-open throttle and then at full brake application simulating high performance driving such as those that may be experienced in vehicle pursuits (e.g., Police City Pursuit Testing). Generally, the known brake aspirators (including those having a by-pass flow path) have less than optimal performance during such tests resulting in hard pedal complaints. Investigation of these systems has identified that the hard pedal complaint is related to a lack of vacuum flow recovery and therefore a lack of brake booster performance. The performance of the known brake vacuum aspirators during such tests may be graphed on a vacuum and pedal force versus time chart as best shown in FIG. 2. The thin red line of the chart in FIG. 2 indicates the measured engine intake manifold vacuum and the thick blue line indicates the measured booster vacuum during the same time period as the warm engine is operated at varying throttle conditions in an ambient environment at 20° C. This may be best seen at about approximately 13 seconds the engine vacuum peaks at throttle tip out while the booster vacuum level is below the engine vacuum peak until approximately 14 seconds at which point the booster vacuum level exceeds the source vacuum level via the aspirator Venturi pump. A similar condition, where the engine vacuum peaks above the brake booster vacuum level resulting in lower brake boost levels, exists between approximately just over two seconds and approximately 4 seconds. Similar performance results for known brake vacuum aspirator designs have been obtained including during an alternative overrun evaluation test as best shown by the chart in FIG. 3. Again, the measured booster vacuum (thick blue line) may be observed below the measured manifold vacuum (thin red line) from approximately 2 seconds until approximately 8 seconds and again from approximately 16 seconds to approximately 19 seconds as best shown in FIG. 3. These slow brake boost recovery periods, wherein the known brake vacuum aspirator has restricted vacuum to assist in the braking of the vehicle, may result in significant vehicle performance issues.

Despite the many known challenges and issues associated with vacuum assisting a booster for a power brake system, today's passenger vehicles continue to use a brake vacuum aspirator having a generally known, standard design including certain drawbacks and limitations that may impede the braking performance of the passenger vehicle. Given the drawbacks and limitations of the existing designs, numerous attempts have been made to improve various performance aspects of the engine, the aspirator and their components for improving the braking performance of the passenger vehicle. Various alterations, additions and improvements to the brake system, engine controls, supplemental vacuum sources (vacuum pump), to the brake vacuum aspirator and to their control systems and related components and systems have been proposed. For example, it has been proposed to add a pump to the vacuum system and integrate its control with the engine for the purpose of improving the performance of the vacuum aspirator and thereby improve the performance of the braking system of the vehicle. Even more recent attempts to improve the performance of the known brake vacuum aspirators have attempted to improve the design of the Venturi pipe (pump) to improve the operating performance of the brake vacuum aspirator. Despite these numerous, expensive and complicated attempts to solve these issues, the known brake vacuum aspirators continue to have notable performance limitations affecting overall braking performance of the passenger vehicle. Notably, despite these improvements, applicant is not aware of any brake vacuum aspirators for use on a braking system in a passenger vehicle utilizing standard brake vacuum aspirator components and having an integrated by-pass check valve air flow rate sufficient enough to capture available engine vacuum transients. The known brake vacuum aspirators generally provide approximately five and one-half cubic feet per minute (5.5 ft³/min or CFM) at approximately seven inches of mercury (7 in Hg). There long remains a significant need for an improved brake vacuum aspirator capable of simply, effectively and cost-efficiently solving the slow recovery of the known brake vacuum aspirators and providing a by-pass check valve air flow rate significantly greater than approximately five and one-half cubic feet per minute (5.5 ft³/min or CFM) at approximately seven inches of mercury (7 in Hg).

### DRAWINGS

FIG. 1 is a schematic view of a known flow diagram for a vacuum aspirator to be coupled to a brake booster and in intake manifold in a vehicle.

FIG. 2 is a chart of the vacuum levels and brake pedal force versus time for a typical brake vacuum aspirator operating according to the flow diagram of FIG. 1 showing engine start at 2 seconds, wide open throttle from four to twelve seconds, and braking from thirteen to nineteen seconds.

FIG. 3 is a chart of the vacuum levels and brake pedal force versus time for a brake vacuum aspirator operating according to the flow diagram of FIG. 1 during an alternative overrun evaluation for a warm vehicle condition showing the slow recovery condition of the known vacuum aspirator of FIG. 1. The vehicle conditions are brake pedal apply, engine start with brake pedal applied, wide open throttle for ten seconds and accelerator tip out at sixteen seconds.

FIG. 4 is a schematic view of a flow diagram for an improved vacuum aspirator to be coupled to a brake booster and an intake manifold in a vehicle according to an exemplary embodiment of the present invention.

FIG. 5 is a chart of the vacuum level and brake pedal force versus time for a brake vacuum aspirator operating according to the flow diagram of FIG. 4 during the alternative overrun evaluation for a warm vehicle condition showing the unexpected fast recovery condition of the vacuum aspirator of FIG. 4 using vehicle and test conditions the same as shown in FIG. 3.

FIG. 6 is a chart of Flow (cubic feet per minute) versus Pressure Differential (inches of mercury) for an optimized vacuum aspirator according to an exemplary embodiment of the present disclosure.

### DETAILED DESCRIPTION

Referring in general to all of the Figures and in particular to FIGS. 4 through 6 there is disclosed an illustration of an exemplary embodiment(s) of a brake vacuum aspirator 100 including an improved by-pass flow path 120 according to the exemplary embodiments of the present disclosure. It may be noted that the details of the connections, hoses and other structures of the generally known portions of the brake vacuum aspirator 100 may not be shown in the illustrations of the Figures since those details are considered to be well understood by a person having ordinary skill in the art of the present disclosure.

The brake vacuum aspirator 100 of the present exemplary embodiment may preferably include a housing or body 101 including a first or filtered air inlet or port 110, a second or brake booster inlet or port 112 and a third or vacuum source outlet or port 113 which may be in air communication with a vacuum source 240. The first air inlet or port 110 may be in air communication with a filtered air source 200. The filtered air source 200 may be of any known or appropriate type for supplying filtered air to the inlet port 110. The vacuum source 240 may be of any known or appropriate type and in one particular exemplary embodiment of the present disclosure, the vacuum source 240 may include the vacuum created by an air manifold of the engine (not shown) or other vacuum source as is well known to one or ordinary skill in the art.

The brake vacuum aspirator 100 further includes a Venturi pump 115 located between the first inlet port 110 and the third outlet port 113 which may generally further define a main flow path 117 in the brake vacuum aspirator 100 which may extend between the first inlet port 110 and the third outlet port 113 as best shown in FIG. 4. The brake vacuum aspirator 100 may further include a bypass flow path 120 in air communication with the second inlet port 112 and in air communication with a first passage 150 and a second passage 160 as best shown in FIG. 4. The functions of the first and second passages 150 and 160, respectively, are well known to those skilled in the art. In the exemplary embodiment of the present disclosure, the bypass flow path 120 may have an optimized and sufficiently larger cross-sectional area A for providing an improved and greater air flow through the bypass flow path 120 for significantly improving the performance of the brake vacuum aspirator 100.

The Venturi pump 115 may preferably be in air communication or coupled with the first passage 150 which may include a first end 151 proximal the Venturi pump 115 and a second end 152 in air communication with and proximal the bypass flow path 120. The first passage 150 may further include a first check valve 153 as may be generally known in the art of vacuum break aspirators and located proximal, at, and/or between the first end 151 and the second end 152.

The second passage 160 may include a first end 161 in air communication with and proximal the main flow path 117 and located distal from the Venturi pump 115 and the first inlet port 110. Accordingly, the second end 161 of the second passage 160 may preferably be located proximal the third outlet port 113. The second passage 160 may also include a second end 162 in air communication with the bypass flow path 120 and the second inlet port 112 which may be in air communication with the brake booster 300. The second passage 160 may also include a second check valve 163 as may generally be known in the art of vacuum break aspirators and located between the first end 161 and the second end 162. While the components and design of the check valve 163 may be similar to those known to a person having ordinary skill in the art, in the present exemplary embodiment, the size of the check valve 163 is optimized and larger than the known check valves as used in brake vacuum aspirators. More particularly, the check valve 163 to provide

In one exemplary embodiment of the present disclosure, the bypass flow path 120 may have an optimized and sufficiently large cross-sectional area A for providing an improved and great air flow through the bypass flow path 120. and the second passage 160 and second check valve 163 may have an effective cross sectional area B (as best shown in FIG. 4) for providing an air flow of preferably approximately nine and one-half cubic feet per minute (9.5 ft³/min) at a pressure of approximately seven inches of mercury (7 in Hg) at the third outlet 113 (i.e., from the vacuum source 240).

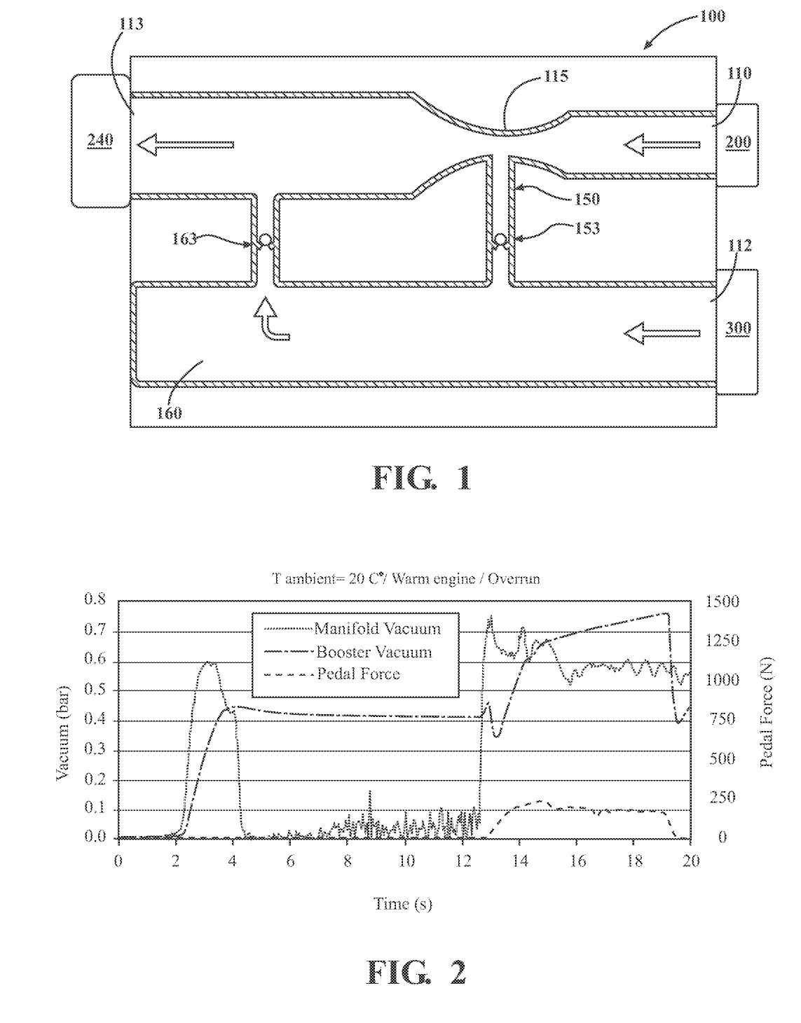

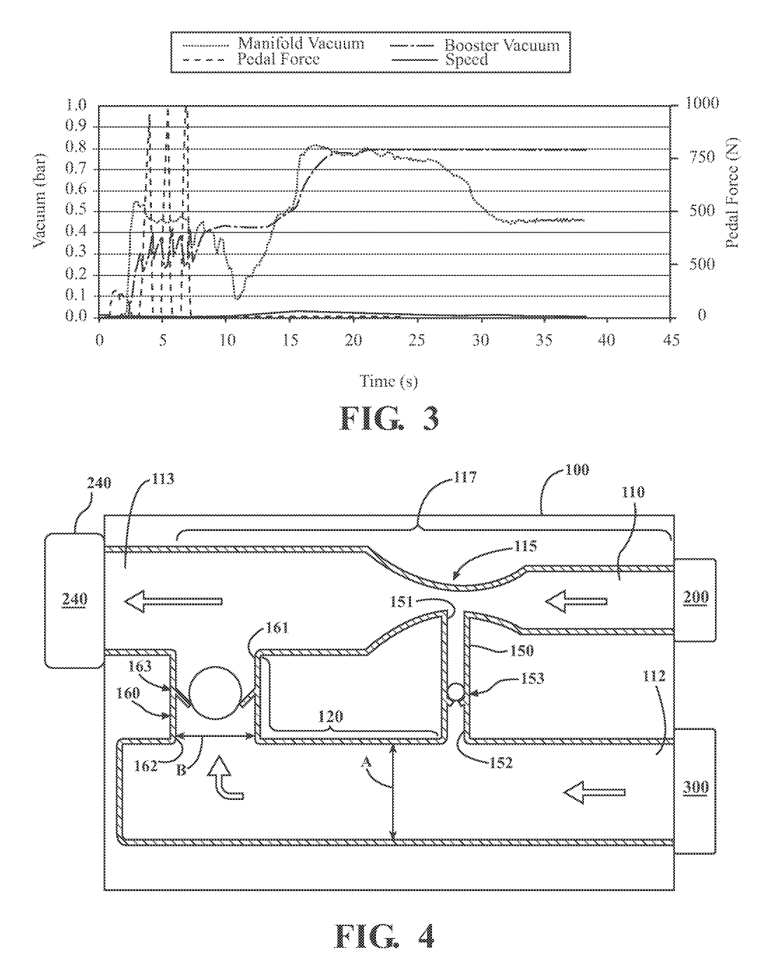

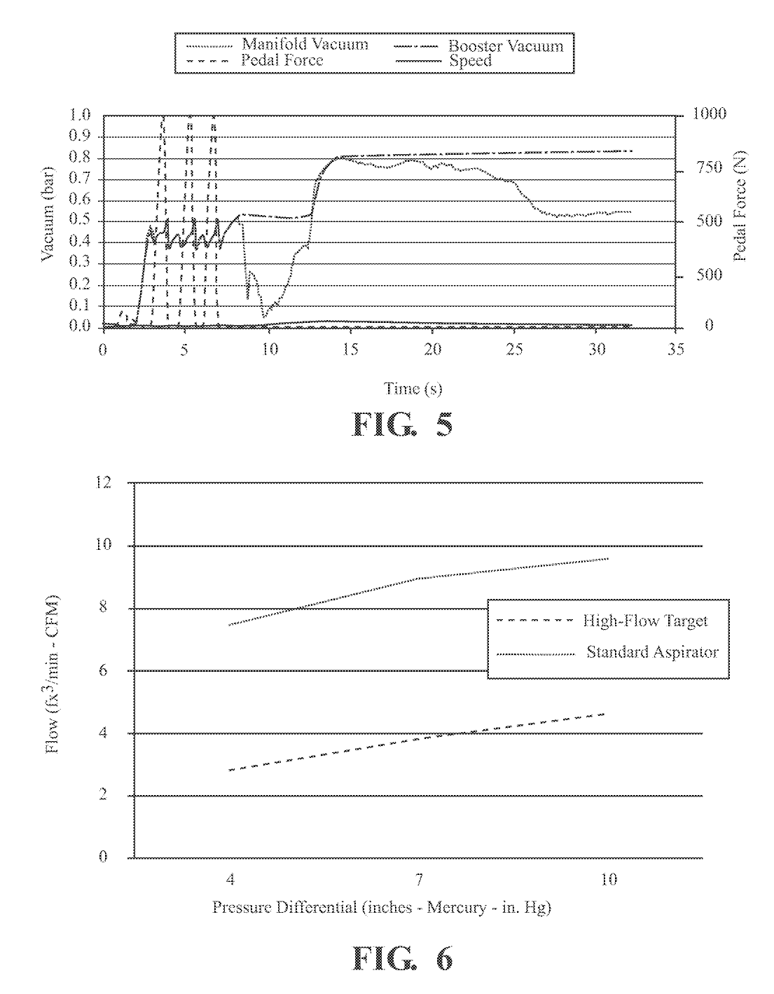

The novel and optimized bypass flow path 120 and second check valve 163 and second passage 160 may preferably be optimized so the brake vacuum aspirator 100 may provide sufficient performance to the brake booster 300 that the vehicle brake system using the brake vacuum aspirator 100 may avoid unacceptably high brake pedal efforts during high performance use. In particular, the brake vacuum aspirator 100 of the exemplary embodiment of the present invention is capable of providing performance to the braking system of the vehicle wherein the vehicle engine is operated at wide-open throttle and then a full brake application is applied and the alternating pattern is repeated multiple times simulating high performance driving such as those that may be experienced in vehicle pursuits, according to the Police City Pursuit Testing test methodology. The brake vacuum aspirator 100 according to the exemplary embodiment of the present disclosure was tested and the results of the testing are shown in FIG. 5 which clearly and unexpectedly shows the improved recovery of the braking vacuum such that booster vacuum 300 has sufficient vacuum from the brake vacuum aspirator 100 that it may complete recover from the cyclic use and the available manifold vacuum pressure is made available by the optimized bypass flow path 120. Additional testing of the optimized brake vacuum aspirator 100 of the exemplary embodiments of the present disclosure have shown that the brake vacuum aspirator 100 provides much greater air flow during high performance testing at all levels of pressure as best shown in FIG. 6 comparing the air flow versus pressure differential for the brake vacuum aspirator 100 (FIG. 4) of the present disclosure compared to a traditional brake vacuum aspirator (FIG. 1).

In one exemplary embodiment of the present invention, the bypass flow path 120 may have a sufficiently large cross-sectional area A and the second passage 160 and the second check valve 163 may have an effective cross sectional area B such that the bypass flow path 120 is capable of providing sufficient flow of air to the third outlet port 113 for providing an air flow of greater than approximately eight cubic feet per minute (8 ft³/min) at a pressure of approximately five inches of mercury (5 in Hg) at the third outlet 113 as shown by the chart in FIG. 6.

In a further alternate exemplary embodiment of the present invention, the bypass flow path 120 may have a sufficiently large cross-sectional area A and the second passage 160 and the second check valve 163 may have an effective cross sectional area B such that the bypass flow path 120 is capable of providing a sufficient flow of air to the third outlet port 113 for providing an air flow of greater than approximately nine and one-half cubic feet per minute (9.5 ft³/min) at a pressure of approximately ten inches of mercury (10 in Hg) at the third outlet 113 as shown by the chart in FIG. 6.

The description and figures are intended to be illustrative and not restrictive. Many alternate embodiments and many applications besides the exemplary embodiments provided will become apparent to those of ordinary skill in the relevant art upon understanding the present disclosure. The scope of the claimed invention should not be determined with limiting reference to the description and figures but should instead be determined with reference to the appended claims along with the full scope of equivalents to which such claims are entitled. Any reference or disclosure of an article or publication, including patents and patent applications, is intended to be an incorporation by reference herein for all purposes. Any omission in the claims of any aspect of subject matter disclosed in the description and figures is not intended to be a disclaimer of such subject matter.

Any numerical values recited herein or in the figures are intended to include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. Unless expressly stated, all ranges are intended to include both endpoints and all numbers between the endpoints. The use of “generally, “about” or “approximately”, or similar words, in connection with a range applies to both ends of the range. Thus, “about 20 to 30” is intended to cover “about 20 to about 30”, inclusive of at least the specified endpoints.

The disclosure of “a” or “one” to describe an element, ingredient, component or step is not intended to foreclose additional elements, ingredients, components or steps. Plural elements, ingredients, components or steps may be provided by a single integrated element, ingredient, component or step. Alternatively, a single integrated element, ingredient, component or step may include separate plural elements, ingredients, components or steps.

1. A brake vacuum aspirator for improving the performance of a brake booster in a passenger vehicle, the brake vacuum aspirator comprising:
a first port for communication with an air source;
a second port for communication with a second air source;
a third port for communication with a vacuum source;
a Venturi pump coupling the first port and the third port, the Venturi pump including a first passage having a first end in communication with the Venturi pump and a second end in communication with the second port, the first passage including a first check valve for allowing air to flow from the second port through the first passage and into the Venturi pump; and
wherein the third port includes a second passage having a first end in communication with the third port and a second end in communication with the second port and the second passage including a second check valve located between the first end and the second end and wherein the second check valve operates as a bypass flow path to the first check valve in the first passage to provide a bypass flow path when the source pressure of the third port is lower than the pressure of the second port.

2. The brake vacuum aspirator of claim 1 wherein the second passage has a cross-sectional area for providing a brake vacuum aspirator capable of providing an air flow rate of at least approximately eight cubic feet per minute (8 ft³/min) at a pressure of approximately seven inches of mercury (7 in Hg) to provide a bypass flow path when the source pressure of the third port is lower than the pressure of the second port.

3. The brake vacuum aspirator of claim 1 wherein the second passage has a cross-sectional area enlarged to provide a brake vacuum aspirator capable of providing an air flow rate of at least approximately eight and one-half cubic feet per minute (8.5 ft³/min) to provide a bypass flow path when the source pressure of the third port is lower than the pressure of the second port.

4. The brake vacuum aspirator of claim 1 wherein the second passage has a cross-sectional area enlarged to provide a brake vacuum aspirator capable of providing an air flow rate of at least nine cubic feet per minute (9 ft³/min) to provide a bypass flow path when the source pressure of the third port is lower than the pressure of the second port.

5. In an improved brake vacuum aspirator for use in a braking system in a passenger vehicle, the brake vacuum aspirator comprising a body comprising:
a first port for communication with an air source;
a second port for communication with a second air source;
a third port for communication with a vacuum source;
a Venturi pump coupling the first port and the third port, the Venturi pump including a first passage having a first end in communication with the Venturi pump and a second end in communication with the second port, the first passage including a first check valve for allowing air to flow from the second port through the first passage and into the Venturi pump; and
wherein the third port includes a second passage having a first end in communication with the third port and a second end in communication with the second port and the second passage including a second check valve located between the first end and the second end and wherein the improvement comprises the second check valve operating as a bypass flow path to the first check valve in the first passage to provide a bypass flow path when the source pressure of the third port is lower than the pressure of the second port.

6. The brake vacuum aspirator of claim 5 wherein the second passage has a cross-sectional area enlarged to provide a brake vacuum aspirator capable of providing an air flow rate of at least approximately eight cubic feet per minute (8 ft³/min) at a pressure of approximately seven inches of mercury (7 in Hg) to provide a bypass flow path when the source pressure of the third port is lower than the pressure of the second port.

7. The brake vacuum aspirator of claim 5 wherein the second passage has a cross-sectional area enlarged to provide a brake vacuum aspirator capable of providing an air flow rate of at least approximately eight and one-half cubic feet per minute (8.5 ft³/min) to provide a bypass flow path when the source pressure of the third port is lower than the pressure of the second port.

8. The brake vacuum aspirator of claim 5 wherein the second passage has a cross-sectional area enlarged to provide a brake vacuum aspirator capable of providing an air flow rate of at least nine cubic feet per minute (9 ft³/min) to provide a bypass flow path when the source pressure of the third port is lower than the pressure of the second port.

9. A brake vacuum aspirator for improving the performance of a brake booster in a passenger vehicle, the brake vacuum aspirator comprising:
a first port for communication with an air source;
a second port for communication with a second air source;
a third port for communication with a vacuum source;
a Venturi pump coupling the first port and the third port, the Venturi pump including a first passage having a first end in communication with the Venturi pump and a second end in communication with the second port, the first passage including a first check valve for allowing air to flow from the second port through the first passage and into the Venturi pump; and
wherein the third port includes a second passage having a first end in communication with the third port and a second end in communication with the second port and the second passage including a second check valve located between the first end and the second end and wherein the minimum cross-sectional area of the second passage and the second check valve is at least greater than approximately XX square inches (XX in²) to provide a bypass flow path when the source pressure of the third port is lower than the pressure of the second port to provide a brake vacuum aspirator capable of providing a bypass air flow rate of at least approximately eight cubic feet per minute (8 ft³/min) at a pressure of approximately seven inches of mercury (7 in Hg) when the source pressure of the third port is lower than the pressure of the second port.

10. The brake vacuum aspirator of claim 9 wherein the second passage has a cross-sectional area enlarged to provide a brake vacuum aspirator capable of providing an air flow rate of at least approximately eight and one-half cubic feet per minute (8.5 ft³/min) to provide a bypass flow path when the source pressure of the third port is lower than the pressure of the second port.

11. The brake vacuum aspirator of claim 9 wherein the second passage has a cross-sectional area enlarged to provide a brake vacuum aspirator capable of providing an air flow rate of at least nine cubic feet per minute (9 ft³/min) to provide a bypass flow path when the source pressure of the third port is lower than the pressure of the second port.
